(19) United States
(12) Patent Application Publication
(10) Pub. No.: US 2024/0238890 A1
(43) Pub. Date: Jul. 18, 2024

(54) WELDING SYSTEM AND WELDING METHOD

(71) Applicant: Fronius International GmbH, Pettenbach (AT)

(72) Inventors: Helmut ENNSBRUNNER, Pettenbach (AT); Guenther REINTHALER, Pettenbach (AT)

(73) Assignee: Fronius International GmbH, Pettenbach (AT)

(21) Appl. No.: 18/619,789

(22) Filed: Mar. 28, 2024

Related U.S. Application Data
(63) Continuation of application No. 17/631,638, filed on Jan. 31, 2022.

(30) Foreign Application Priority Data
Aug. 1, 2019 (EP) 19189617.4

(51) Int. Cl. B23K 9/09; B23K 9/095

(52) U.S. Cl. CPC B23K 9/091; B23K 9/0956

(57) ABSTRACT

A welding system has a welding current source providing a process parameter that varies periodically with a period; a process controller specifying the period of the process parameter; a power unit; a sensor for acquiring process variables when triggered and/or a process actuator for influencing process parameters when triggered; and a port connecting the sensor and/or the process actuator to the welding current source. At least one of the sensor and the process actuator is triggered by the periodically varying process parameter according to a predefined trigger condition. A user interface connected to the welding current source is operable to specify the predefined trigger condition for triggering the sensor and/or the process actuator within the period of the process parameter and to set a defined trigger signal. If the predefined trigger condition is satisfied, the defined trigger signal is transferred via the port to the sensor and/or the process actuator.

### CROSS REFERENCE TO RELATED APPLICATIONS

This application is a Continuation Application and Applicant claims priority under 35 U.S.C. § 120 of U.S. patent application Ser. No. 17/631,638 which was filed on Jan. 31, 2022, which application is a national stage application under 35 U.S.C. § 371 of PCT Application No. PCT/EP2020/071519 filed on Jul. 30, 2020, which claims priority under 35 U.S.C. § 119 of European application Ser. No. 19/189,617.4 filed on Aug. 1, 2019, the disclosures of which are incorporated by reference. The international application under PCT article 21(2) was not published in English.

### 1. FIELD OF THE INVENTION

The invention relates to a welding system with a welding current source for providing at least one process parameter, varying periodically with a period, a process controller for specifying the period of the at least one process parameter, a power unit, and at least one port for connecting to at least one sensor for acquiring process variables and/or with at least one process actuator for influencing process parameters, wherein the at least one sensor and/or the at least one process actuator can be triggered by the periodically varying process parameter according to at least one predefined trigger condition.

### 2. DESCRIPTION OF THE RELATED ART

Furthermore, the invention relates to a welding method in which in a welding current source at least one process parameter is varied periodically with a period, wherein a process controller is used to specify the period of the at least one process parameter, and a power unit generates the at least one process parameter, and via at least one port at least one sensor for acquiring process variables and/or at least one process actuator for influencing process parameters is connected, wherein the at least one sensor and/or the at least one process actuator is triggered by the at least one periodically varying process parameter according to at least one predefined trigger condition.

In particular, the present invention relates to a welding system and a welding method with a welding current source for providing a welding current that varies periodically with a period as the process parameter. Further process parameters, such as the welding voltage, the welding power, etc. are also specified by the welding current source or are determined by the respective process. The period of the periodically varying process parameters does not need to be constant, but may change in the course of the process. This is in particular the case found in practice with a real welding process. In a short-circuit-based welding process, for example, the period of the welding process consisting of a short-circuit phase and an arc phase will always be subject to a certain amount of fluctuation due to the corresponding regulation systems of the welding parameters. Different numbers of process parameters can occur in the respective process. The process parameters that can be influenced by the process actuators are one or more of the periodically varying process parameters of the respective process.

In addition to arc welding systems, laser welding systems or laser hybrid welding systems for connecting or coating metallic workpieces are also possible, as well as plasma processing systems, in which the surface of workpieces is treated with a plasma beam, for example, in order to clean them or prepare them for subsequent processes. For example, plasma processing systems are used to clean the surfaces of workpieces before painting or coating processes.

The term process variable refers to a wide range of physical variables that are dependent on the process or influenced by the process. For example, in a welding process, the geometry or width of the weld seam can be measured by an optical sensor as a process variable or, for example, the temperature of the weld seam can be measured by a thermal sensor as another process variable.

Depending on the application, the process parameters are controlled in different ways by the process controller. The actual time course of the process parameters is again dependent on the current process operation and usually deviates from the desired course in an unpredictable way.

With such periodically varying process parameters, triggering of sensors and/or process actuators upon specific events during each period is often necessary or desirable for specific tasks. Usually, for particular sensors or process actuators there are predefined trigger conditions which cannot be influenced or modified, or only to a very limited extent. The actual course of the at least one periodically varying process parameter again influences the triggering of the sensors and/or process actuators.

For example, in welding technology, cameras or welding shields are known which are triggered by the periodically varying welding current of the welding current source, by starting the image acquisition of the camera or the closure of the screen cassette by means of a trigger condition on the welding current.

Document EP 2 475 489 B1 describes a monitoring module for monitoring an arc process, having a camera and a light source, which is controlled synchronously with the observed arc process.

The article “Online-Schmelzbaddiagnostik zum Überwachen der Qualität und Vermeiden von Fehlern beim Lichtbogenschweißen” (Uwe Reisgen et al., Schweißen und Schneiden, Volume 66, Issue 5, May 1, 2014, pages 243-249, DVS Verlag, Düsseldorf, DE) describes an arc welding method in which a camera for acquiring the melt bath geometry is used to monitor the quality of the welding process and the images recorded with the camera are subsequently evaluated in an internal processor.

US 2004/0034608 A1 describes an optical system for monitoring an arc welding process, wherein an automatic control of welding parameters using neural networks is performed to reduce the complexity of the control of the welding parameters and to achieve a stable material transition during the welding process.

Conventional welding current sources usually only have specific ports for specific sensors and/or process actuators, which can be controlled synchronously with a periodically varying process parameter according to predefined trigger conditions. Any influence on the trigger conditions is usually not possible, or only with great effort. If a process parameter is changed, the trigger condition cannot also be changed.

### SUMMARY OF THE INVENTION

The object of the present invention is to create a welding system and welding method referred to above, wherein the trigger conditions for sensors and/or process actuators to be connected to the welding current source can be specified and changed in a particularly flexible manner in order to be able to specify optimum trigger conditions for the selected process parameters of the welding process for various types of sensors and/or process actuators. The sensors and/or process actuators to be triggered should thus be able to be controlled as smoothly as possible depending on the respective periodically varying process parameter. Disadvantages of known welding systems or welding methods should be avoided or at least reduced.

The object according to the invention is achieved by a welding system mentioned above, wherein a user interface is provided which is connected to the welding current source, via which user interface the at least one trigger condition for triggering the at least one sensor and/or the at least one process actuator can be specified and at least one trigger signal can be transferred via the at least one port to the at least one sensor and/or the at least one process actuator. According to the invention, a user interface is thus provided on or connected to the welding current source, via which user interface the trigger conditions for different sensors and/or process actuators that can be connected to the welding current source can be specified in a particularly flexible manner. The specified trigger condition or a corresponding trigger signal is then transferred, for example, via a port to which the sensor and/or process actuator can be connected. The port can be arranged on the welding current source, for example, but can also be provided on another device which is connected to the welding current source. The term port refers to both wire-bound connectors, such as plug connectors, and to wireless interfaces or connections, such as Bluetooth® or other radio connections. Thus, on the one hand, the respective sensors and/or process actuators can be optimally adapted to match the respective periodically varying process parameter and any sensors and/or process actuators can also be connected to the welding current source for specific purposes and can be synchronized in a suitable manner with at least one periodically varying process parameter. This also opens up new applications, for example, for monitoring a welding process with a periodically varying process parameter. A plurality of sensors and/or process actuators can be triggered with joint trigger conditions or each with their own trigger conditions. The user interface does not necessarily have to be operated by a person, but can also be operated by a machine, for example.

For example, the user interface can be formed by a web interface. For example, a notebook that can be connected to the welding current source can be used to access a website which forms the user interface for specifying the trigger condition. This allows a graphical display of at least one periodically varying process parameter and at the same time, a clear and simple means of specifying the trigger conditions. Instead of web interfaces, simple controls and displays or touchscreens on the welding current source or connected units are also possible.

For example, a sensor can be formed by an optical sensor or contain an optical sensor. Often, the monitoring of process variables with an optical sensor, such as a camera, is necessary or desirable, wherein the optical sensor must be appropriately triggered by at least one periodically varying process parameter. For example, in order to achieve a good image quality of a camera in an arc welding process, it is necessary to take the camera pictures while there is no arc burning, for example during the short-circuit phases of a short-circuit-based welding process.

A sensor can also be formed by an inductive or capacitive sensor or can contain an inductive or capacitive sensor. Such sensors can also be used to acquire certain properties of a process, for example, for quality monitoring. It is also necessary or convenient to trigger the inductive or capacitive sensor accordingly in order to minimize disruptive influences of the at least one periodically varying process parameter on the process variable to be acquired.

Other examples of sensors include distance sensors, such as laser systems for distance measurement, radiation sensors for monitoring an arc, sensors for keyhole monitoring (monitoring of the point of incidence of the laser) in laser processing machines, magnetic field sensors, voltage sensors with conductor loops, and many more.

A process actuator can be formed by a manipulator, such as a robot or a linear undercarriage. Such manipulators must also be suitably controlled and triggered by the periodically varying process parameter.

A process actuator can also be formed by a motor for feeding wires. For example, the current or the speed of motors for feeding welding wires, so-called hot wires, can be triggered.

Other examples of triggerable process actuators include ultrasonic transducers, laser sources, lighting equipment and many more.

According to another feature of the invention, the process controller is designed to modify at least one process parameter on the basis of at least one trigger condition specified on the user interface. In this case, a trigger condition specified via the user interface affects the process parameters. For example, a specific trigger condition can only be selected and specified for a specific minimum duration of the period of a process parameter. If the duration of the period is set below this minimum duration on the process controller, the process controller can be overtuned, so to speak, via the specified trigger condition and, under certain circumstances, the process can be changed automatically or after confirmation by a user. In addition to manipulating the temporal properties of the process parameter, other properties such as amplitude, gradients, or the like, of the process parameter can also be manipulated by the trigger condition.

If the process controller is designed to provide at least one trigger signal already at a predefined time period before the at least one trigger condition and to transfer it via the at least one port, a so-called “pre-trigger” can be achieved. Since the process controller has knowledge of the period and the course of the at least one process parameter (at least its target values), the connected sensors and/or process actuators can already be triggered a certain predefined time before the trigger time. For example, this can be used to compensate for a delay due to the inertia of certain sensors and/or process actuators, as well as transmission or signal propagation delays. According to another feature of the invention, the length of time before the trigger time by which the triggering of a connected sensor or process actuator is to be triggered can also be automatically specified or set as soon as the sensor and/or process actuator is connected to the port. This represents a variant of an automatic setting of the pre-trigger by detecting the sensor and/or process actuator connected to the port.

The object according to the invention is achieved in terms of the method by the fact that the at least one trigger condition for triggering the at least one sensor and/or the at least one process actuator is specified via a user interface connected to the welding current source, and via the at least one port at least one trigger signal is transferred to the at least one sensor and/or the at least one process actuator. The method according to the invention allows a flexible specification of different trigger conditions for a wide range of sensors and/or process actuators, regardless of the course of the respective periodically varying process parameter during the particular welding process. For details of the advantages achievable as a result, reference is made to the above description of the welding system.

It is advantageous that at least one process parameter is displayed graphically on the user interface and the at least one trigger condition is defined on the at least one graphically displayed process parameter. This allows a simple and individual definition of the appropriate trigger conditions for the sensors and/or process actuators used.

Trigger conditions can be specified, for example, as trigger points within the period of the at least one periodically varying process parameter. For example, the zero crossing of the process parameter, or a time that is a certain duration before or after this zero crossing, can be defined as a trigger point.

At least one process parameter can be changed based on at least one trigger condition defined on the user interface. This relates to the case described above that, based on a particular defined trigger condition, the periodically varying process parameter can be influenced. For example, such a change in the process parameter by the process controller may be necessary to achieve a particular trigger condition. The influence of the trigger condition on the process sequence can occur automatically or after confirmation by a user.

If at least one trigger signal is transmitted via the at least one port at a predefined time period before the at least one trigger condition, a “pre-trigger” as already mentioned above can be realized.

### BRIEF DESCRIPTION OF THE DRAWINGS

The present invention will be explained in further detail by reference to the attached drawings. Shown are:

FIG. 1 a block diagram of a welding current source for providing a periodically varying welding current and with sensors for acquiring process variables;

FIG. 2 a time characteristic of a periodically varying process parameter;

FIG. 3 a time characteristic of a welding current with different trigger conditions;

FIG. 4 a trigger time as another example of a trigger condition;

FIG. 5 exceeding or undershooting of a trigger threshold as another example of a trigger condition; and

FIG. 6 an example of a so-called “pre-trigger”.

### DETAILED DESCRIPTION OF THE DRAWINGS

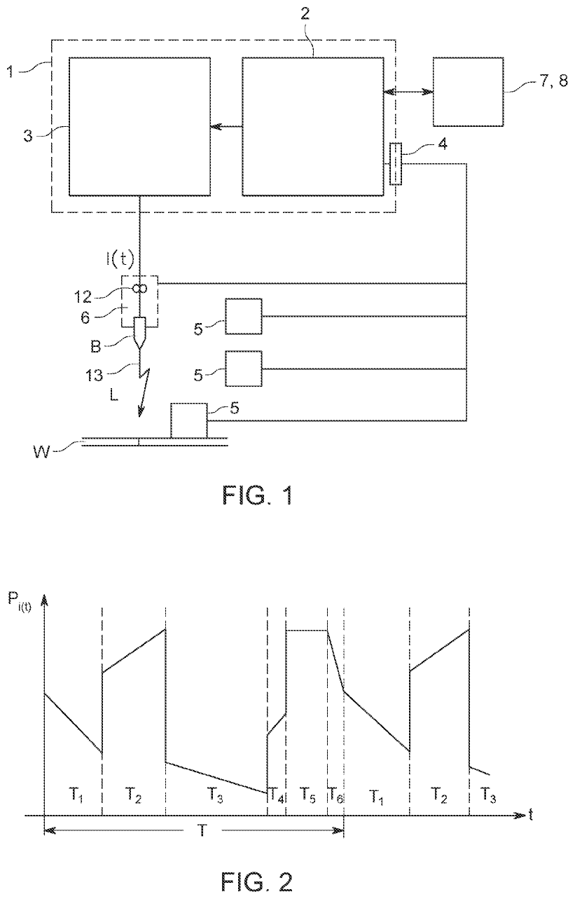

FIG. 1 shows a block diagram of a welding current source 1 for providing at least one periodically varying welding current I(t) as a process parameter Pᵢ(t). The welding current source 1 for providing the periodically varying process parameter Pᵢ(t) has a process controller 2, which specifies the period T of the process parameter Pᵢ(t). For example, the process controller 2 of the welding current source 1 defines the duration of a short-circuit phase KS and the duration of an arc phase LB as the period T of the periodically varying welding current I(t). The function of the process controller 2 is defined by inputs at the welding current source 1 (for example, the selection of a so-called welding characteristic). For example, the process controller 2 can also be a function block of a regulation of the welding current source 1. The process controller 2 can therefore be configured as software, i.e. not physically, or else physically in the form of a hardware component. The respective process parameter Pᵢ(t) is applied to an output via a power unit 3 of the welding current source 1, for example, the welding current I(t) is routed to a welding torch B so that a corresponding arc L can be ignited between the welding torch B and a workpiece W to be processed.

Various sensors 5 and/or process actuators 6 are connected to the welding current source 1 via a port 4, which can be formed by a wired or wireless interface. The sensors 5 can be used for monitoring the process and for acquiring specific process variables Gⱼ(t). Different process actuators 6 can be used to influence process parameters Pᵢ(t). The sensors 5 and/or process actuators 6 can also be connected to other devices which are connected to the welding current source 1. For example, sensors 5 in the form of cameras can also be connected to a robot connected to the welding current source 1. For example, a process actuator 6 can be formed by a motor 12 for feeding a welding wire 13.

According to the invention, a user interface 7 connected to the welding current source 1 is provided, via which the at least one trigger condition B₁ for triggering at least one sensor 5 and/or at least one process actuator 6 can be specified. The specified trigger condition B₁ for the at least one sensor 5 and/or the at least one process actuator 6, or a corresponding trigger signal, is then transferred accordingly to the port 4, thereby ensuring that the at least one sensor 5 and/or the at least one process actuator 6 are triggered according to the specified trigger conditions B₁ by the at least one periodically varying process parameter Pᵢ(t), i.e., for example, by the welding current I(t). The port 4 is used to enable a preferably bidirectional data exchange with the sensor 5 and/or process actuator 6. For example, the user interface 7 can be formed by a web interface 8 or similar. This enables a convenient and simple means of specifying the trigger condition B₁, for example in graphical form. The user interface 7 can be operated either manually by a user or automatically by a machine. For example, such machines can be formed by sensors or actuators which can be adjusted via their own optimum values.

Instead of the welding current source 1 shown in FIG. 1 for an arc welding process, a welding current source for operating a laser for a laser welding process, or a welding current source for generating both an arc and a laser for a laser hybrid welding process, can also be provided. In addition, the welding current source 1 can also be formed by a plasma current source for generating a plasma beam for a plasma process, such as a surface treatment process or a cutting process (not shown).

FIG. 2 shows a characteristic of a process parameter Pᵢ(t) that varies periodically as a function of the time t. In the example shown, a period T of the periodically varying process parameter Pᵢ(t) is composed of six different process phases T₁ to T₆, which are characterized by a specific course of the process parameter Pᵢ(t) within these process phases Tₘ. For example, these are the phases of a welding current I(t) in a welding process. The period T and also the process phases Tₘ present within the period T do not need to be constant, but can also vary. The course of the at least one process parameter Pᵢ(t) is specified and defined in the process controller 2 of the welding current source 1 according to a user's settings.

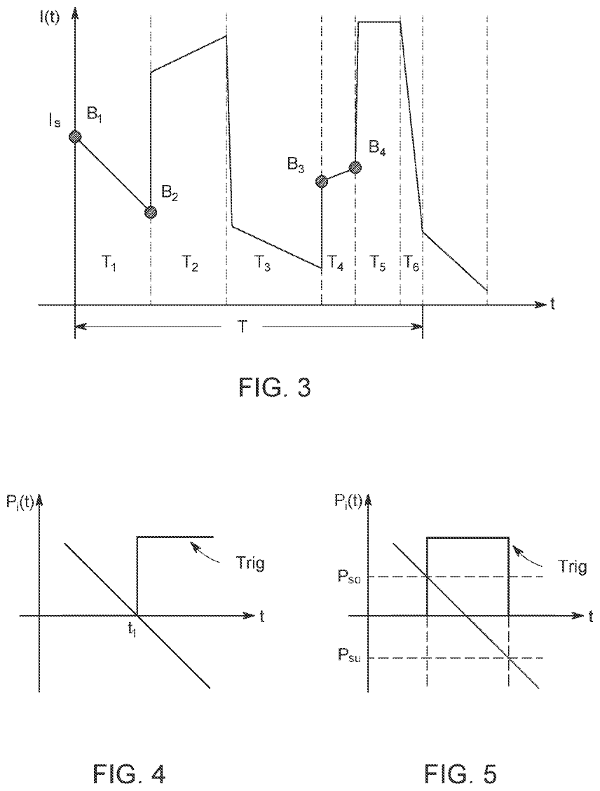

FIG. 3 shows the characteristic of the welding current I(t) as a function of the time t. During a period T of the periodically varying welding current I(t), for example, there are six process phases T₁ to T₆. Four different trigger conditions B₁ to B₄ are shown as examples. The trigger condition B₁ is defined by undershooting a predefined threshold I_{S} of the welding current I(t). Trigger condition B₂ is characterized by the start of a pulsed current phase during a process phase T₂. The trigger condition B₃ is characterized by the end of the rise in the welding current I(t) at the end of the process phase T₃. Finally, the trigger condition B₄ is characterized by an increase in the rising slope of the welding current I(t) at the end of the process phase T₄. This represents only an arbitrary selection of possible trigger conditions B₁, which are selected or specified according to the sensors 5 and/or process actuators 6 used and to be triggered.

In welding technology, the trigger conditions also depend on the respective welding process. In MIG (metal inert-gas) or MAG (metal active-gas) welding, the start and end of the short-circuit phase can be suitable trigger conditions when using a short-circuit-based welding process. For example, in a pulsed-arc welding method, the start and end of a pulsed base current phase can be selected as a trigger condition. In TIG (tungsten inert-gas) welding with direct current (DC) and current pulses, the start and end of a pulsed base current phase can also be used as a trigger condition. In TIG welding with alternating current (AC), the zero crossing of the welding current (change from negative welding current to positive welding current and vice versa) can be used as a trigger condition.

For example, an optical sensor 5 can be triggered at the start of a short-circuit phase for imaging a weld seam during a welding process, so that a signal is provided only during the short-circuit phase, in which no arc L is burning and no interference of the sensor signal by the arc L takes place. The trigger condition B₁ specified using the user interface 7 defines the trigger signal Trig, which is transferred via the port 4 and directed to the sensor 5 and/or the process actuator 6. For example, the user interface 7 can be formed by a web interface 8. A user can use a notebook to open a specific website and use it to specify the trigger conditions B₁ for a desired sensor 5 for acquiring a specific process variable Gⱼ(t), or a process actuator 6 for influencing a process parameter Pᵢ(t). During the process, corresponding trigger signals are then transferred to the sensor and/or the process actuator 6 via the port 4 according to the defined trigger conditions.

Instead of a manual specification of the trigger conditions B₁ by a user via the user interface 7, automatic specifications of the trigger conditions B₁ via the user interface 7 are also possible. For example, when connecting or attaching a particular sensor 5 to the welding current source 1, a trigger condition B₁ suitable for this sensor 5 can also be automatically specified in the user interface 7.

If a particular trigger condition B₁ is selected, which can only be achieved with a specific characteristic of a process parameter Pᵢ(t), a change of the at least one process parameter Pᵢ(t) can also take place due to the specified trigger condition B₁. In this case, a specified trigger condition B₁ thus has an effect on the process controller 2 of the welding current source 1. For example, temporal properties of a process parameter Pᵢ(t) or the amplitude or rise of a process parameter Pᵢ(t) can be changed due to the trigger condition B₁.

FIG. 4 shows the characteristic of a process parameter Pᵢ(t) as a function of the time t. The zero crossing of the process parameter Pᵢ(t) is specified as the trigger condition. As soon as the trigger condition is satisfied, i.e. the process parameter Pᵢ(t) crosses the time axis t at the time t₁, the trigger is triggered and a corresponding trigger signal Trig is transferred via the port 4.

FIG. 5 shows the characteristic of a process parameter Pᵢ(t) as a function of the time t for further trigger conditions. The trigger conditions are defined, for example, as the overshooting or undershooting of an upper threshold P_{SO} of the process parameter Pᵢ(t) and the overshooting or undershooting of a lower threshold P_{SU} of the process parameter Pi(t). As soon as the first trigger condition occurs, in the exemplary embodiment shown the upper threshold Pₛₒ of the process parameter Pᵢ(t) is undershot, the trigger is triggered or the trigger signal Trig is switched on. After the second trigger condition has been satisfied, in the exemplary embodiment shown, the lower threshold value Pₛᵤ of the process parameter Pᵢ(t) is undershot, the trigger is deactivated or the trigger signal Trig is switched off again.

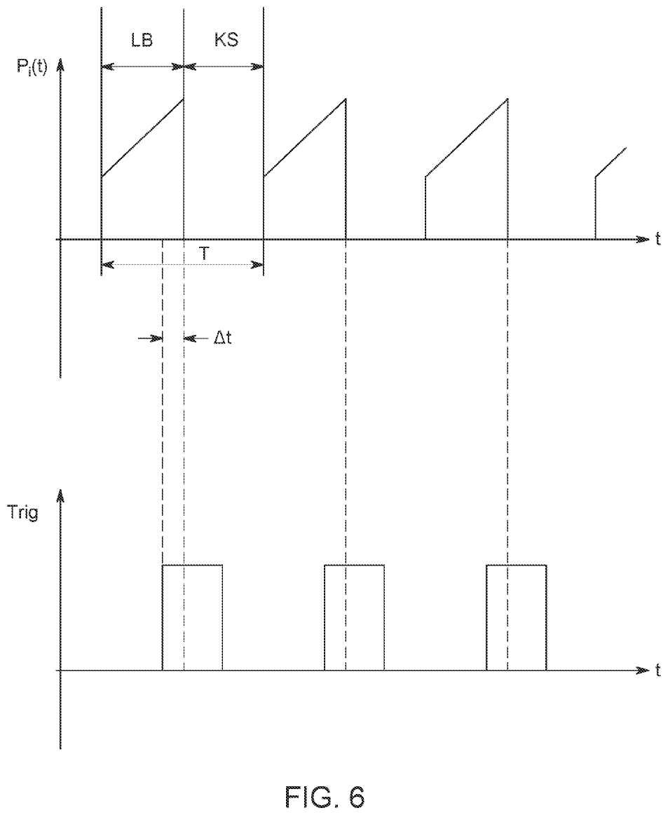

Finally, FIG. 6 shows the example of a so-called “pre-trigger”. The upper diagram shows a process parameter Pᵢ(t) that varies periodically as a function of the time t. For example, this is the welding current I(t) as the process parameter Pᵢ(t), which passes through an arc phase LB and a short-circuit phase KS during a period T. A predefined time period Δt before the start of the short-circuit phase KS is specified as the trigger condition B₁. The trigger, or trigger signal Trig, (lower diagram) is thus activated at this predefined time period Δt before the start of the short-circuit phase KS and deactivated again, for example, after a certain duration has elapsed. This allows, for example, delays of sensors 5 or process actuators 6 as well as signal propagation times to be balanced out or compensated. The time period Δt can also be stored in a sensor 5 or process actuator 6 and can be set automatically when the sensor 5 or process actuator 6 is used. As mentioned briefly above, the sensor 5 and/or the process actuator 6 can also be detected automatically as soon as it is connected to the port 4 and a corresponding time period Δt, which is stored for this sensor 5 and/or process actuator 6, are automatically set as the value for the pre-trigger. This triggers the connected sensor 5 and/or process actuator 6 automatically with a stored value for the time period Δt before (or even after) the trigger time.

This invention allows a particularly flexible specification of trigger conditions B₁ on a user interface 7 of a welding current source 1 of a welding system.

1. A welding system comprising:
a welding current source for providing a process parameter that varies periodically with a period;
a process controller for specifying the period of the process parameter;
a power unit;
at least one of a sensor for acquiring process variables when triggered and a process actuator for influencing process parameters when triggered;
a port connecting at least one of the sensor and the process actuator to the welding current source;
wherein at least one of the sensor and the process actuator is triggered by the periodically varying process parameter according to a predefined trigger condition; and
a user interface connected to the welding current source,
wherein the user interface is operable to specify the predefined trigger condition for triggering at least one of the sensor and the process actuator within the period of the process parameter and to set a defined trigger signal;
wherein if the predefined trigger condition is satisfied, the defined trigger signal is transferred via the port to at least one of the sensor and the process actuator and therefore at least one of the sensor and the process actuator is triggered by the process parameter according to the predefined trigger condition and the defined trigger signal.

2. The welding system according to claim 1, wherein the process parameter comprises a welding current.

3. The welding system according to claim 1, wherein the user interface is formed by a web interface.

4. The welding system according to claim 1, wherein the sensor comprises an optical sensor.

5. The welding system according to claim 1, wherein sensor comprises an inductive or a capacitive sensor.

6. The welding system according to claim 1, wherein the process actuator comprises a manipulator.

7. The welding system according to claim 6, wherein the manipulator comprises a robot or a linear undercarriage.

8. The welding system according to claim 1, wherein the process actuator comprises a motor for feeding wires.

9. The welding system according to claim 1, wherein the process controller is designed to modify the process parameter based on the predefined trigger condition specified with the user interface.

10. The welding system according to claim 1, wherein the process controller is designed to provide at least one trigger signal at a predefined time period before the predefined trigger condition and to transfer the trigger signal via the port.

11. A welding method, comprising the steps of:
generating a process parameter with a power unit;
periodically varying the process parameter with a period using a welding current source;
specifying the period of the process parameter using a process controller;
connecting at least one of a sensor for acquiring process variables when triggered and a process actuator for influencing process parameters when triggered to the welding current source via a port;
specifying a predefined trigger condition for triggering at least one of the sensor and the process actuator via a user interface connected to the welding current source within the period of the process parameter;
setting a defined trigger signal via the user interface; and
triggering at least one of the sensor and the process actuator by the process parameter according to the predefined trigger condition by transferring the defined trigger signal to at least one of the sensor and the process actuator via the port if the predefined trigger condition is satisfied;
wherein at least one of the sensor and the process actuator is triggered by the process parameter according to the predefined trigger condition and the defined trigger signal.

12. The welding method according to claim 11, wherein the process parameter comprises a welding current.

13. The welding method according to claim 11, further comprising the steps of graphically displaying the process parameter on the user interface and specifying the predefined trigger condition the graphically displayed process parameter.

14. The welding method according to claim 11, further comprising the step of specifying trigger times within the period of the process parameter as the predefined trigger condition.

15. The welding method according to claim 11, further comprising the step of changing the process parameter based on the predefined trigger condition specified on the user interface.

16. The welding method according to claim 11, further comprising the step of transferring the trigger signal via the port at a predefined time period before the predefined condition.
